(19) United States
(12) Patent Application Publication
(10) Pub. No.: US 2020/0017746 A1
(43) Pub. Date: Jan. 16, 2020

(54) BASE FLUID FOR HEAT MEDIUM, HEAT TRANSFER SYSTEM USING THE BASE FLUID, AND HEAT PUMP SYSTEM USING THE BASE FLUID

(71) Applicant: DENSO CORPORATION, Kariya-city (JP)

(72) Inventors: Junichi NARUSE, Kariya-city (JP); Touru KAWAGUCHI, Kariya-city (JP); Kouji INAGAKI, Kariya-city (JP); Takashi KANEKO, Kariya-city (JP)

(21) Appl. No.: 16/558,372

(22) Filed: Sep. 3, 2019

Related U.S. Application Data
(63) Continuation of application No. PCT/JP2018/005621, filed on Feb. 19, 2018.

(30) Foreign Application Priority Data
Mar. 7, 2017 (JP) 2017-042897

(51) Int. Cl. C09K 5/20; F28F 23/00

(52) U.S. Cl. CPC C09K 5/20; F28F 23/00

(57) ABSTRACT

A base fluid for heat medium contains a hydrophilic ionic liquid and water. A molecular weight of the hydrophilic ionic liquid is at or below 150. The hydrophilic ionic liquid is methylammonium nitrate. Since the ionic liquid has favorable thermal stability, the thermal stability of the base fluid for heat medium can be secured. Since the molecular weight of the hydrophilic ionic liquid is at or below 150, the base fluid for heat medium has a low kinematic viscosity. Further, since the freezing point depression effect can be obtained by dissolving the ionic liquid in water, a low freezing point can be realized.

### CROSS REFERENCE TO RELATED APPLICATION

The present application is a continuation application of International Patent Application No. PCT/JP2018/005621 filed on Feb. 19, 2018, which designated the U.S. and claims the benefit of priority from Japanese Patent Application No. 2017-042897 filed on Mar. 7, 2017. The entire disclosures of all of the above applications are incorporated herein by reference.

### TECHNICAL FIELD

The present disclosure relates to a base fluid for heat medium, a heat transfer system using the base fluid, and a heat pump system using the base fluid.

### BACKGROUND

Conventionally, an ethylene glycol aqueous solution is widely used as a base fluid of a heat medium such as coolant or antifreeze liquid for an internal combustion engine and a heat pump. The 50 v/v % ethylene glycol aqueous solution has a freezing point of −32 degrees Celsius and a kinematic viscosity at 25 degrees Celsius of 3.13 mm²/s.

The viscosity of such ethylene glycol aqueous solution increases with a decrease of the outside air temperature. For this reason, when ethylene glycol aqueous solution is used as coolant, the load to the water pump which circulates the coolant may become large when the temperature is low, and it may shorten the life of the water pump.

### SUMMARY

A base fluid for heat medium according to a first aspect of the present disclosure includes a hydrophilic ionic liquid and water. A viscosity of the hydrophilic ionic liquid at 25 degrees Celsius is at or below 30 mPa·s.

A base fluid for heat medium according to a second aspect of the present disclosure includes a hydrophilic ionic liquid and water. A molecular weight of the hydrophilic ionic liquid is at or below 150.

### BRIEF DESCRIPTION OF THE DRAWINGS

FIG. 1 is a diagram illustrating a heat-pump type water heater according to at least one embodiment of the present disclosure.

FIG. 2 is a diagram illustrating a heat-pump type water heater according to at least one embodiment of the present disclosure.

### EMBODIMENTS

A conventional base fluid for heat medium contains 20 wt % to 70 wt % of formamide and/or methylformamide, 80 wt % to 30 wt % of water, and 0.1 wt % to 10 wt % of rust inhibitor. This base fluid for heat medium has the similar thermal properties (freezing point etc.) to conventional ethylene glycol aqueous solution, and its kinematic viscosity is about 1.5 mm²/s. For this reason, the viscosity of the coolant may be reduced, and the load on the water pump may decrease.

However, since formamide hydrolyzes at a high temperature, the concentration of formamide may decrease due to high temperature when this base fluid for heat medium is used as coolant for the internal combustion engine or antifreeze for the heat pump. The working temperature of the coolant for the internal combustion engine is between −34 degrees Celsius and 120 degrees Celsius, and the working temperature of antifreeze for the heat pump is between −30 degrees Celsius and 100 degrees Celsius. The concentration of formamide decreases by about 20% after 100 hours at 80 degrees Celsius.

An ionic liquid containing a predetermined pyrrolidinium cation is known as a base fluid for heat medium which has favorable thermal stability.

Kinematic viscosity of this base fluid for heat medium may be high.

For example, N-methoxymethyl-N-methylpyrrolidinium bis (fluorosulfonyl) amide (MMMP⋅FSA) has a relatively low viscosity, and it is 20 cP. An average of densities of similar base fluids is 1.25 g/cc, and the kinematic viscosity derived from the value is 16 mm²/s. This is about five times higher than that of the conventional 50 v/v % ethylene glycol aqueous solution, and indicates that the dynamic viscosity of this heat medium substrate is very high.

The inventors have studied and found that a base fluid containing a hydrophilic ionic liquid having a predetermined physical property and water has a low viscosity, a low freezing point, and a high thermal stability.

Hereinafter, embodiments for carrying out the present disclosure will be described with reference to the drawings. In each embodiment, portions corresponding to the elements described in the preceding embodiments are denoted by the same reference numerals, and redundant explanation may be omitted. In each of the embodiments, when only a part of the configuration is described, the other parts of the configuration can be applied to the other embodiments described above. The parts may be combined even if it is not explicitly described that the parts can be combined. The embodiments may be partially combined even if it is not explicitly described that the embodiments can be combined, provided there is no harm in the combination.

Embodiments according to the present disclosure are hereinafter described with reference to the drawings. In the following embodiments, identical or equivalent constituent elements are designated with identical symbols.

### First Embodiment

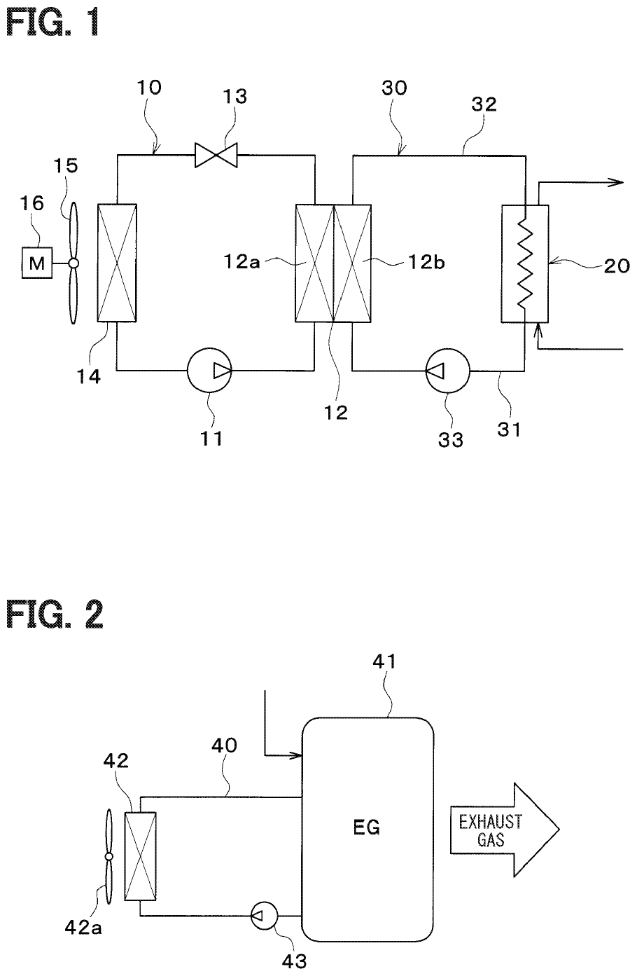

A first embodiment of the present disclosure will be described with reference to FIG. 1. In the present disclosure, a base fluid for heat medium of the present disclosure is used in a heat-pump type water heater that is a heat pump system.

A heat-pump type water heater of the present embodiment includes a heat pump cycle 10, a radiator 20, and a heat medium circulation circuit 30, for example, as shown in FIG. 1. The heat-pump type water heater is configured to heat the heat medium by the heat pump cycle 10 and heat water that is a heating target fluid by using the heat medium as a heat source.

The heat pump cycle 10 is a vapor compression type refrigeration cycle that heats the heat medium. The radiator 20 is a heat exchanger that releases the heat of the heat medium by exchanging heat between the water and the heat medium heated by the heat pump cycle 10, and thereby heats the water. The heat medium circulation circuit 30 is a heat medium circuit in which the heat medium circulates between a heat medium-refrigerant heat exchanger 12 of the heat pump cycle 10 and the radiator 20.

Specifically, in the heat pump cycle 10, a compressor 11, the heat medium-refrigerant heat exchanger 12, an expansion valve 13, and an evaporator 14 are connected in order through pipes.

The compressor 11 draws, compresses, and discharges the refrigerant in the heat pump cycle 10. The compressor 11 is an electric compressor which drives a fixed capacity type compression mechanism by an electric motor.

A refrigerant inlet side of a refrigerant passage 12a of a heat medium-refrigerant heat exchanger 12 is connected to a discharge port of the compressor 11. The heat medium-refrigerant heat exchanger 12 includes the refrigerant passage 12a through which the refrigerant discharged from the compressor 11 and having high pressure flows, and a heat medium passage 12b through which the heat medium circulating in the heat medium circulation circuit 30 flows. The heat medium-refrigerant heat exchanger 12 is a heating heat exchanger that heats the heat medium by exchanging the high-pressure refrigerant flowing through the refrigerant passage 12a and the heat medium flowing through the heat medium passage 12b.

An outlet side of the refrigerant passage 12a of the heat medium-refrigerant heat exchanger 12 is connected to an inlet side of the expansion valve 13. The expansion valve 13 is a variable throttle mechanism that decompresses and expands the refrigerant flowing out of the refrigerant passage 12a. The expansion valve 13 is an electric expansion valve having a valve body configured to change a throttle opening degree and an electric actuator for changing the throttle opening degree of the valve body.

A refrigerant inlet side of the evaporator 14 is connected to an outlet side of the expansion valve 13. A suction port side of the compressor 11 is connected to a refrigerant outlet of the evaporator 14. The evaporator 14 is a heat-absorbing outside heat exchanger that exchanges heat between the low-pressure refrigerant decompressed by the expansion valve 13 and the outside air (the air outside the passenger compartment) blown by the blower fan 15. Accordingly, the low-pressure refrigerant evaporates and exerts a heat absorbing function.

A blower fan 15 includes a fan motor 16 and rotates with the rotation of the fan motor 16.

The heat medium circulation circuit 30 includes a low-temperature side heat medium passage 31 and a high-temperature side heat medium passage 32. The low-temperature side heat medium passage 31 guides the low-temperature heat medium that has released heat in the radiator 20 toward the inlet of the heat medium passage 12b of the heat medium-refrigerant heat exchanger 12. The high-temperature side heat medium passage 32 guides the high-temperature heat medium flowing out of the heat medium passage 12b of the heat medium-refrigerant heat exchanger 12 toward the inlet of the radiator 20.

A heat medium circulation pump 33 is provided in the low-temperature heat medium passage 31. The heat medium circulation pump 33 draws the heat medium flowing out of the radiator 20, pressurizes the heat medium, and sends the heat medium toward the heat medium passage 12b of the heat medium-refrigerant heat exchanger 12.

The heat medium of the present embodiment contains the base fluid for heat medium containing a hydrophilic ionic liquid and water. The molecular weight of the hydrophilic ionic liquid contained in the base fluid for heat medium is at or below 150, or the viscosity at 25 degrees Celsius is at or below 30 mPa·s.

The ionic liquid is a salt in the liquid state and is a compound in the liquid state composed only of ion (anion or cation). In general, the ionic liquid is in the liquid state when the temperature is between −30 degrees Celsius and 300 degrees Celsius. Further, since the change the physical properties of the ionic liquid is small even when the temperature exceeds 300 degrees Celsius, the thermal resistance is high.

Ammonium-based ionic liquids and imidazolium-based ionic liquids shown in Table 1 below may be used as the hydrophilic ionic liquid of the present embodiment.

TABLE 1

| Composition of | Molecular | Viscosity at 25° C. |
|---|---|---|
| Ionic Liquid | Weight | (mPa · s) |
| Methyl ammonium nitrate | 94.07 | Solid |
| 1-Ethyl-3-methyl-Imidazolium | 146.62 | Solid |
| Chloride (EMIC) | | |
| 1-Ethil-3-methyl-Imidazolium | 177.21 | 21.4 |
| Dicyanamide (EMID) | | |
| 1-Ethyl-3-methyl-Imidazolium | 169.25 | 23.1 |
| Thiocyanate (EMIT) | | |

Methylammonium ion (CH₃NH₃⁺) is used as a cation component of the ammonium-based ionic liquid, for example. Nitrate ion (NO₃⁻) is used as an anion component of the ammonium-based ionic liquid, for example.

That is, methylammonium nitrate may be used as the ammonium-based ionic liquid, for example. The molecular weight of methylammonium nitrate is small and lower than 150, or light.

Imidazolium ion, more specifically, 1-ethyl-3-methyl-imidazolium ion is used as a cation component of imidazolium-based ionic liquid, for example. (CN)₂N⁻, SCN⁻, Cl⁻ are used as an anion component of imidazolium-based ionic liquid, for example.

That is, 1-ethyl-3-methyl-imidazolium chloride (EMIC), 1-ethyl-3-methyl-imidazolium dicyanamide (EMID), 1-ethyl-3-methyl-imidazolium thiocyanate (EMIT) may be used as imidazolium-based ionic liquid, for example. The molecular weight of EMIC is small and lower than 150, or light. A viscosity of EMID at 25 degrees Celsius is 21.4 mPa·s and small, and the interaction between ions is small. Similarly, a viscosity of EMIT at 25 degrees Celsius is 23.1 mPa·s and small, and the interaction between ions is small.

The freezing point and the kinematic viscosity of the ethylene glycol aqueous solution that is a comparative example and those of the base fluid for heat medium that is an aqueous solution obtained by mixing the above-described ionic liquid and water are measured. The results are shown in Table 2 below. The freezing point was measured by differential scanning calorimetry (DSC). The kinematic viscosity was measured at room temperature (25 degrees Celsius) using a rotational viscometer (Brookfield).

TABLE 2

| | Concen- | | Kinematic |
|---|---|---|---|
| Composition of | tration | Freezing Point | Viscosity |
| Ionic Liquid | (wt %) | (° C.) | (mm²/s) |
| Methyl ammonium nitrate | 56.6 | at or below −30° C. | 1.61 |
| 1-Ethyl-3-methyl-Imidazolium | 51.1 | at or below −30° C. | 2.79 |
| Chloride (EMIC) | | | |
| 1-Ethil-3-methyl-Imidazolium | 68.4 | at or below −30° C. | 2.99 |
| Dicyanamide (EMID) | | | |
| 1-Ethyl-3-methyl-Imidazolium | 70.1 | at or below −30° C. | 3.28 |
| Thiocyanate (EMIT) | | | |
| Comparative Example: | 53 | at or below −30° C. | 3.13 |
| Ethylene Glycol | | | |

As shown in Table 2, the concentration of the ionic liquid in the base fluid for heat medium of the present embodiment is at or above 50 wt %, and the freezing point of the base fluid is at or below −30 degrees Celsius. Since the freezing point of the ethylene glycol aqueous solution is at or below −30 degrees Celsius, the base fluid for heat medium of the present embodiment has a freezing point substantially equal to that of the ethylene glycol aqueous solution.

Further, the base fluid for heat medium of the present embodiment has a kinematic viscosity at 25 degrees Celsius equal to or less than that of the ethylene glycol aqueous solution that is the comparative example. Specifically, when the methylammonium nitrate, EMIC, or EMID is used as the ionic liquid, the kinematic viscosity at 25 degrees Celsius is at or below 3.1 mm²/s which is lower than that of the ethylene glycol aqueous solution at 25 degrees Celsius. Further, when the methylammonium nitrate is used as the ionic liquid, the kinematic viscosity at 25 degrees Celsius is 1.61 mm²/s which is about half of the kinematic viscosity of ethylene glycol aqueous solution at 25 degrees Celsius.

As described above, the base fluid for heat medium according to the present embodiment contains the hydrophilic ionic liquid and water. That is, the hydrophilic ionic liquid is dissolved in water. According to this, since the ionic liquid has favorable thermal stability, the thermal stability of the base fluid for heat medium can be secured. Further, since the freezing point depression effect can be obtained by dissolving the ionic liquid in water, a low freezing point can be realized.

The Coulomb interaction between ions (anion and cation) of the hydrophilic ionic liquid having a low viscosity is smaller than that of solid salts. Accordingly, the Coulomb interactions between ions and between ion and a water molecule can be suppressed by dissolving the hydrophilic ionic liquid in water, and ion mobility can be improved. Accordingly, viscosity of heat medium that is an aqueous solution of the hydrophilic ionic liquid can be small.

Specifically, as described above, the kinematic viscosity of the base fluid for heat material can be decreased by using the hydrophilic ionic liquid having viscosity at 25 degrees Celsius of 30 mPa·s or lower. The kinematic viscosity of the base fluid for heat medium can be decreased by using the hydrophilic ionic liquid whose molecular weight is at or below 150.

### Second Embodiment

A second embodiment of the present disclosure is described below with reference to FIG. 2. In the present embodiment, the base fluid for heat medium according to the present embodiment is used in a coolant of a cooling system for an engine (internal combustion engine) that is used as one driving source for traveling of a hybrid vehicle. That is, according to the present embodiment, a heat transfer system of the present disclosure is used in an engine cooling system.

As shown in FIG. 2, the engine cooling system of the present embodiment is a system for cooling the coolant of an engine 41 by a radiator 42. That is, the engine cooling system of the present embodiment is a system transferring heat of the engine 41 to the radiator 42 through the coolant that is a liquid heat medium flowing through a coolant passage 40.

The engine 41 is an energy converting portion that generates heat during converting the fuel that is an energy supplied from an outside into motive power which is energy of another form.

The radiator 42 is a heat exchanger that cools the coolant by exchanging heat between the coolant, which heated by the heat exchange with the exhaust heat of the engine 41, and the air outside the passenger compartment (outside air) sent from a blower fan 42a. The radiator 42 of the present embodiment may correspond to a heat radiation portion of the present disclosure. The blower fan 42a is an electric blower whose operation rate, that is, rotation speed (blowing air volume) is controlled by a control voltage output from a controller (not shown).

The engine 41 and the radiator 42 are connected through a coolant passage 40 that forms a closed circuit between the engine 41 and the radiator 42. A pump 43 that circulates the coolant in the coolant passage 40 is provided in the coolant passage 40. The coolant in the coolant passage flows from the refrigerant outlet of the engine 41 to the refrigerant inlet of the engine 41 through the radiator 42.

The coolant passage 40 forms a passage through which the coolant that is a liquid heat medium flows, and may correspond to a heat medium passage of the present disclosure. The coolant passage 40 is constituted by metal coolant pipes.

The pump 43 is a flow generator that causes the coolant to flow in the coolant passage 40. The pump 43 of the present embodiment is an electric pump whose rotation speed (that is, a water pressure-feeding capacity) is controlled by a control voltage output from the controller (not shown).

The base fluid for heat medium described in the first embodiment is used as the coolant of the present embodiment. That is, since the coolant of the present embodiment contains the hydrophilic ionic liquid and water as in the first embodiment, a low viscosity and a low freezing point can be realized with a secured thermal stability.

The present disclosure is not limited to the foregoing embodiments and can be modified in various manners within the scope of the present disclosure without departing from the spirit of the present disclosure, as in examples described below.

In the above-described embodiments, methylammonium nitrate, EMIC, EMID, EMIT are used as the ionic liquid. However, the ionic liquid is not limited to these.

In the above-described embodiment, an example where the base fluid for heat medium containing the hydrophilic ionic liquid are used as the heat medium. However, the heat medium is not limited to this. For example, the heat medium may contain the above-described base fluid and another solvent. The solvent can be appropriately selected depending on the usage and the use conditions of the heat medium.

In the above-described embodiments, the base fluid for heat medium of the present disclosure is used as the heat medium of the heat pump system. However, the usage of the base fluid for heat medium is not limited to this. The base fluid for heat medium of the present disclosure may be used as coolant for devices used at high temperature such as internal combustion engine, a fuel cell, a heat pipe, and a motor. The base fluid may be used in another way such as antifreeze.

In addition, various components of the heat pump cycle 10 are not limited to those disclosed in the above-described first embodiment.

For example, in the first embodiment, an electric compressor is used as the compressor 11. However, an engine drive type compressor may be used when the vehicle includes an internal combustion engine. Further, a variable capacity type compressor configured to adjust the refrigerant discharge capacity by changing the discharge capacity may be used as the engine drive type compressor.

In the first embodiment, an electric expansion valve is used as the expansion valve 13. However, a thermal expansion valve that adjusts the passage throttle area by a mechanical structure such that the degree of superheat of the refrigerant on the outlet side of the evaporator 14 is within a predetermined range.

In the first embodiment, the heat pump system of the present disclosure is used in the heat pump type water heater. However, the usage of the heat pump system is not limited to this. The heat pump system of the present disclosure may be used in another device such as a heat pump type air-conditioner, for example.

In the second embodiment, the heat transfer system of the present disclosure is used in the engine cooling system of a hybrid vehicle. However, the usage of the heat transfer system is not limited to this.

For example, the heat transfer system may be used in an engine cooling system of a vehicle which obtains driving power for traveling from the engine. The usage of the heat transfer system of the present disclosure is not limited to a vehicle. The heat transfer system may be used in a stationary cooling system, for example.

The heat transfer system may be used in an air-conditioning system in which heat generated in the energy converting portion is used for heating an air-conditioning air. In this case, a heater core that exchanges heat between the heat medium and the air-conditioning air may be used as the heat radiation portion.

In the above-described second embodiment, an engine is used as the energy converting portion. However, the energy converting portion is not limited to this. For example, a fuel cell, an electric motor for traveling, a battery, an inverter may be used as the energy converting portion.

The radiator is used as a heat radiation portion in the above-described second embodiment. However, the heat radiation portion is not limited to the radiator. For example, a refrigerant-cooling type chiller may be used as the heat radiation portion.

Although the present disclosure has been described in accordance with the embodiments, it is understood that the present disclosure is not limited to the embodiments and structures disclosed therein. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A base fluid for heat medium, comprising:
a hydrophilic ionic liquid and water, wherein
a molecular weight of the hydrophilic ionic liquid is at or below 150, and
the hydrophilic ionic liquid is methylammonium nitrate.

2. The base fluid for heat medium according to claim 1, wherein
a concentration of the hydrophilic ionic liquid is at or above 50 wt %.

3. The base fluid for heat medium according to claim 1, wherein
a kinematic viscosity of the hydrophilic ionic liquid at 25 degrees Celsius is at or below 3.1 mm²/s.

4. A heat transfer system comprising:
a heat medium passage through which a heat medium in liquid state flows;
a flow generator that causes the heat medium to flow through the heat medium passage;
an energy converting portion that is provided in the heat medium passage and generates heat during converting a supplied energy from an outside into energy of another form; and
a heat radiation portion that is provided in the heat medium passage and radiates heat of the heat medium, wherein
the heat of the energy converting portion is transferred to the heat radiation portion through the heat medium, and
the base fluid for heat medium according to claim 1 is used as the heat medium.

5. A heat pump system comprising:
a heat pump cycle that heats a heat medium to heat a heating target fluid by using the heated heat medium, wherein
the base fluid for heat medium according to claim 1 is used as the heat medium.
